(19) United States
(12) Patent Application Publication
(10) Pub. No.: US 2012/0176437 A1
(43) Pub. Date: Jul. 12, 2012

(54) RECORDING APPARATUS

(75) Inventor: Hidenori USUDA, Matsumoto-shi (JP)

(73) Assignee: Seiko Epson Corporation, Tokyo (JP)

(21) Appl. No.: 13/347,581

(22) Filed: Jan. 10, 2012

(30) Foreign Application Priority Data
Jan. 12, 2011 (JP) 2011-003728

(51) Int. Cl. B41J 29/38; B41J 2/01

(52) U.S. Cl. 347/16; 347/102

(57) ABSTRACT

A recording apparatus includes: a transporting section that transports a recording target medium in a transporting direction; a recording head that discharges ink to the recording target medium from a nozzle; and a radiating unit that is disposed further downstream than the recording head in the transporting direction, at the same side as the recording head with respect to the recording target medium, and radiates electromagnetic waves that cure the ink, wherein the radiating unit irradiates to a range wider than the recording target medium in the a first direction crossing the transporting direction, and a portion that radiates the electromagnetic waves in the radiating unit is divided into a plurality of blocks in the first direction.

The entire disclosure of Japanese Patent Application No: 2011-003728, filed Jan. 12, 2011 is expressly incorporated by reference herein in its entirety.

### BACKGROUND

1. Technical Field

The present invention relates to a recording apparatus that discharges ink from a recording head and radiates electromagnetic waves to the ink landed on a recording target medium such that the ink is hardened by chemical reaction.

It is assumed herein that the recording apparatus includes an ink jet printer, a line printer, a copy machine, a fax machine, and the like.

2. Related Art

In the related art, as described in JP-A-2005-104108 and JP-A-2004-314304, an ink jet printer includes a recording head and an ultraviolet radiating unit disposed around the recording head. In the components, the recording head includes a nozzle that discharges ultraviolet curable ink onto a paper sheet. Further, the ultraviolet radiating unit is disposed at the same side as the recording head with respect to the paper sheet.

Therefore, it is possible to cure ink by radiating ultraviolet rays onto the ink landed on the paper sheet.

However, the ultraviolet radiating unit is disposed in a carriage having a recording head and the ultraviolet radiating unit simply radiates ultraviolet rays onto a position right after ink is landed. Accordingly, the ultraviolet rays are radiated to a narrow range and energy efficiency was not sufficient. Further, since the amount of radiated ultraviolet rays was constant, there were positions that were unnecessarily irradiated, such that the energy efficiency was insufficient.

### SUMMARY

An advantage of an aspect of the invention, there is provided a recording apparatus implemented in consideration of the energy efficiency when curing ink landed on a recording target medium by radiating electromagnetic waves onto the ink.

According to an aspect of the invention, there is provided a recording apparatus including: a transporting section that transports a recording target medium in a transporting direction; a recording head that discharges ink to the recording target medium from a nozzle; and a radiating unit that is disposed further downstream than the recording head in the transporting direction, at the same side as the recording head with respect to the recording target medium, and radiates electromagnetic waves that cure the ink, wherein the radiating unit irradiates to a range wider than the recording target medium in the a first direction crossing the transporting direction, and a portion that radiates the electromagnetic waves in the radiating unit is divided into a plurality of blocks in the first direction.

Light curable ink may be exemplified as the ink that is cured by a chemical reaction generated by electromagnetic waves. “The light curable ink” is ink that is cured (solidified) by receiving radiated light. The light includes ultraviolet rays, visible light, and infrared rays. For example, there is ultraviolet curable (solidifying) ink (UV ink) that is cured by receiving radiated ultraviolet rays. The change in volume during curing (solidifying) is small in comparison to the dye ink or pigment ink in which the solvent of the ink volatilizes (solidifies). As the technical idea, it is preferable that the curing (solidifying) be achieved by a chemical reaction of components, such as resin, in the ink by energy supplied from electromagnetic waves. The ink is not limited to the ink that is cured (solidified) by ultraviolet rays.

According to the aspect, it is possible to cure the ink landed a wide area at a time in the width direction. Further, it is possible to cure the ink landed in a wide area at a time in the transporting direction by increasing the range where the radiating unit can perform radiation in the transporting direction. As a result, it is possible to improve energy efficiency in comparison to configurations of the related art.

Further, since the radiating portion in the radiating unit is divided into a plurality of blocks, it is possible to adjust the radiation amount for each block.

In the recording apparatus of the aspect may further include a control unit that controls driving of the transporting unit, the recording head, and the radiating unit, the control unit may change the radiation amount of the electromagnetic waves for each of the blocks in the radiating unit in accordance with the amount of landed ink per unit area at the position where the electromagnetic waves are radiated in the recording data.

According to this configuration, in addition to the same operational effect as the aspect, the radiation amount is changed in accordance with the amount of landed ink per unit area. Therefore, it is possible to adjust the electromagnetic waves that are necessary to cure the ink at the position, as energy. As a result, it is possible to equally cure the ink at the positions where the amount of landed ink per unit area is large and small, such that curing non-uniformity is not caused.

Further, energy is also saved because it is possible to prevent an unnecessarily large amount of electromagnetic waves from being radiated to the positions where the amount of landed ink per unit area is small. Further, since the control of adjusting the radiation amount is performed for each block, the control is easier than when the light emitting amount of LEDs that generate ultraviolet rays, which is an example of electromagnetic waves, one by one.

Further, it is possible to prevent an increase in the amount of contraction of the ink, which is an example of a defect due to radiation of an unnecessarily large amount of electromagnetic waves.

In the recording apparatus, the control unit may decrease the radiation amount of the block opposite to the position with a relatively small landed amount, and increase the radiation amount of the blocks opposite to the position with a relatively larger landed amount than the position with the small landed amount, more than that for the position with the small landed amount.

According to this configuration, in addition to the same operational effect as the above configuration, it is possible to cure the ink in a wide area on the recording target medium at a time without curing non-uniformity. Further, since the radiation is performed on the paused recording target medium, it is easier to change the radiation amount than when radiation is performed on a moving recording target medium.

In the recording apparatus, the radiating portion in the radiating unit may be divided into a plurality of blocks in the transporting direction.

According to this configuration, in addition to the same operational effect as the above configuration, it is possible to sequentially cure the ink without curing non-uniformity while changing the radiation amount in accordance with the landed amount for each of blocks at the transported positions. Since the radiation is performed on the transported recording target medium, it is possible to shorten the radiating unit in the transporting direction. The blocks may be in one line in the transporting direction, which is useful for reducing the size of the recording apparatus.

For example, this is useful for a line printer that continuously transports recording target medium at a predetermined speed.

The recording apparatus according to the aspect may further include a control unit that controls driving of the transporting unit, the recording head, and the radiating unit, and the control unit may perform intermittent transporting that repeats transporting and pausing of the recording target medium by a predetermined distance in a range where radiation of the radiating unit is performed by the transporting unit in the transporting direction, and causes the radiating unit to radiate the electromagnetic waves to the recording target medium, when the recording target medium is paused.

According to this configuration, in addition to the same operational effect as that of any one of the above configurations, it is possible to achieve uniform curing without curing non-uniformity by adjusting the radiation amount to a necessary amount, even if the radiation amount of electromagnetic waves for curing is different in accordance with the type of ink. Although the components of the ink are different in accordance with the types of the ink, for example, the black component of black ink absorbs light and radiated light is absorbed at position close to the surface of ink droplets, such that the inside far from the surface may be difficult to cure. Further, since white ink using titanium oxide or metallic color-based ink using aluminum uses metal, light, such as the radiated ultraviolet rays, is reflected from positions close to the surface of ink droplets, such that the inside far from the surface may be difficult to cure. Uniform curing without curing non-uniformity can be achieved by adjusting the radiation amount in accordance with the types of ink in consideration of this inclination.

The recording apparatus according to the aspect may further include a control unit that controls driving of the transporting unit, the recording head, and the radiating unit, and the control unit may perform continuous transporting for continuously transporting the recording target medium by using the transporting unit and changes the radiation amount of the electromagnetic waves for each of the blocks in accordance with the landed amount of the ink, at the position with the ink landed on the recording target medium.

The recording apparatus according to the aspect may further include a control unit that controls driving of the transporting unit, the recording head, and the radiating unit, and the control unit may change the amount of electromagnetic waves radiated from the radiating unit in accordance with the type of the ink.

### BRIEF DESCRIPTION OF THE DRAWINGS

The invention will be described with reference to the accompanying drawings, wherein like numbers reference like elements.

FIG. 1 is a side view schematically showing a printer according to an embodiment.

FIGS. 2A and 2B are a front view and a plan view schematically showing a recording section according to the embodiment, respectively.

FIGS. 3A to 3C are front views showing the operation of the recording section according to the embodiment.

FIG. 4 is a view showing the operation of the recording section according to the embodiment.

FIG. 5 is a side view schematically showing a printer according to another embodiment.

FIGS. 6A and 6B are views showing the radiation amount for each block of the radiating unit according to another embodiment.

FIGS. 7A to 7D are views showing the radiation amount for each block of the radiating unit according to another embodiment.

### DESCRIPTION OF EXEMPLARY EMBODIMENTS

Hereinafter, embodiments of the invention are described with reference to the drawings.

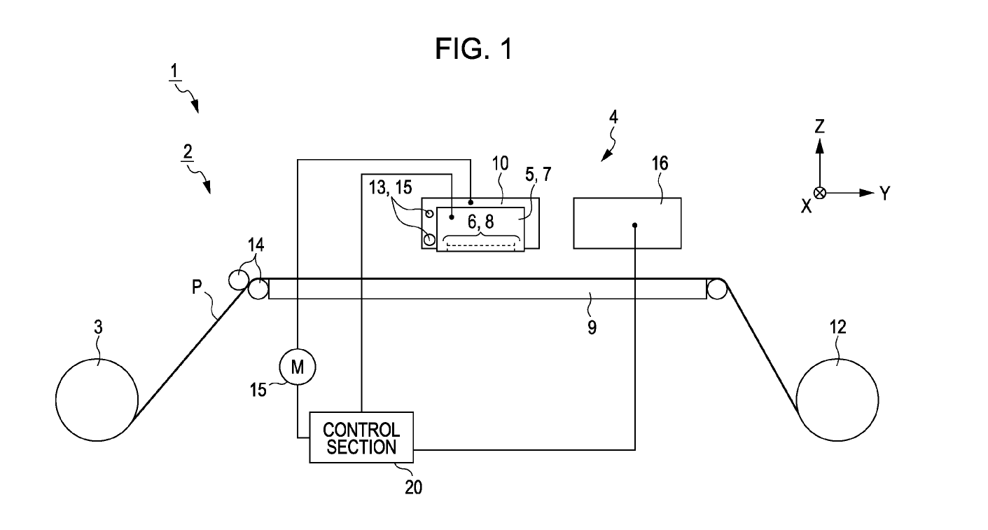

FIG. 1 is a side view schematically showing a printer 1 that is an example of a recording apparatus according to the invention.

As shown in FIG. 1, the printer 1 includes a medium transporting section 2, a recording section 4, and a winding unit 12 that is an example of a discharging section. The medium transporting section 2 in the components is disposed to transport rolled paper P, which is a rolled medium that is an example of a recording target medium, to the downstream side in the transporting direction (the direction of the arrow of a Y axis).

The medium transporting section 2 includes, in detail, a sending unit 3 and a pair of rollers 14. The sending unit 3 in the components is disposed to release and send out the rolled paper P wound in a roll shape to the downward side in the sending direction. Further, the pair of rollers 14 is disposed to send the released rolled paper P to the recording section 4 at the further downstream side.

Further, the recording section 4 is disposed to perform recording by discharging ink onto the rolled paper P at a further downstream side than the medium transporting section 2.

In detail, the recording section 4 includes a first recording head 5 and a second recording head 7, which are recording heads, and a medium supporting section 9. A first nozzle 6 that is a nozzle discharging ink is disposed on a surface opposite to the medium supporting section 9 of the first recording head 5 in the components. Similarly, a second nozzle 8 is disposed on a surface opposite to the medium supporting section 9 in the second recording head 7.

Further, the first recording head 5 and the second recording head 7 are disposed in a carriage 10. Further, the carriage 10 is movable in the width direction X of the rolled paper P by power of a guide shaft 13 that is a carriage moving unit 15 and a driving motor M. Further, the carriage 10 is moved by the control of a control section 20.

Further, the medium supporting section 9 is disposed to maintain the distance between the rolled paper P and the first and second recording heads 5 and 7 by a predetermined distance while supporting the rolled paper P. Further, the Z-axial direction is a direction where the medium supporting section 9 and the first and second recording heads 5 and 7 face each other. Further, it is also the vertical direction.

Further, a first radiating unit 16 that can radiate ultraviolet rays W, which is an example of electromagnetic waves W that can cure ink, is disposed at a further downstream side than the first recording head 5 and the second recording head 7 in the transporting direction, above the medium supporting section 9. The first radiating unit 16 is disposed in a panel shape of an LED arrangement structure and can irradiate a range larger than the width of the rolled paper P. Further, the portion radiating ultraviolet rays W in the first radiating unit 16 is divided into a plurality of blocks 16a, 16b, . . . at least in the width direction X, which is described in detail below. Further, it is possible to adjust the radiation amount of ultraviolet rays W for each of the blocks 16a, 16b, . . . .

The winding unit 12 is disposed to wind the rolled paper P that has been recorded, at a further downstream side than the recording section 4.

Further, although the rolled paper P is described as an example of the roll medium, the roll medium is not limited to the rolled paper P. Obviously, fabric (cloth) or film may be used. Further, the recording target medium is not limited to the roll shape. A so-called single sheet of paper may be used.

Next, the first recording head 5, the second recording head 7, the first radiating unit 16, and the like are described in more detail.

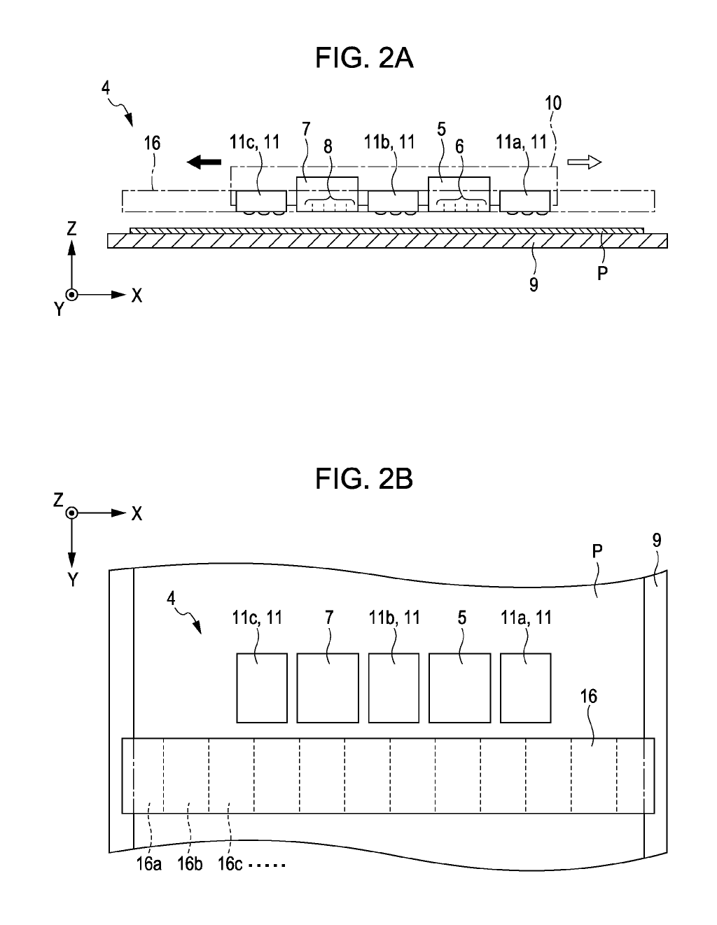

FIGS. 2A and 2B are a front cross-sectional view and a plan view schematically showing the recording section 4 according to the embodiment, respectively. In the figures, FIG. 2A is a front cross-sectional view seen from downstream side to the upstream side in the transporting direction. Meanwhile, FIG. 2B is a plan view of FIG. 2A. Further, the carriage 10 is not shown to make understanding of FIG. 2B easy.

As shown in FIG. 2A, the carriage 10 is disposed at a side (above) from the rolled paper P on the medium supporting section 9.

Further, as shown in FIGS. 2A and 2B, the first radiating unit 16 having a panel shape is disposed at (above) the side where the carriage 10 is disposed. Further, the first radiating unit 16 is disposed at a further downstream side than the carriage 10 in the transporting direction. In addition to the first recording head 5 and the second recording head 7 which are described above, second radiating units 11a to 11c (11) that can radiate ultraviolet rays W, which are an example of electromagnetic waves W that can cure ink, are disposed at the carriage 10. A total of three second radiating units 11 are disposed, one between the first recording head 5 and the second recording head 7 and two are both sides outside the first recording head 5 and the second recording head 7. Further, the radiating units are implemented to integrally move in the width direction X.

The first recording head 5 is equipped with a first nozzle 6 that discharges first type of ink L1 onto the rolled paper P. In the embodiment, ink L1, such as cyan, magenta, yellow, and black, is discharged.

Meanwhile, the second recording head 7 is equipped with a second nozzle 8 that discharges second type of ink L2. White ink L2 is discharged in the embodiment.

The “first type of ink” is ink that mainly creates information on an image (character, figure, and shape). The first type of ink is the ink discharged to a position above the layer of the second type of ink L2, with an observer at the upper side, when being used with the second type of ink L2. In detail, the first type of ink is chromatic ink or achromatic ink except for white. For example, cyan, magenta, yellow, and black ink may be used. Further, the “second type of ink” is ink used for the base of white and metal colors. It is possible to contribute to expressing the color of the “first type of ink” discharged onto the base by using the “second type of ink” for the base.

Obviously, it is possible to independently use only the “first type of ink”.

Further, the printer 1 according to the embodiment has a first recording mode and a second recording mode. The first recording mode in the modes is a mode that performs recording by discharging the second type of ink L2 first and then discharging the first type of ink L1 onto the second type of ink. The first recording mode is a recording mode that is used when the recording target medium P is paper or the like and characters, shapes, pictures or the like are shown from the recorded surface (the surface with the ink discharged).

The second recording mode is a mode that performs recording by discharging the first type of ink L1 first and then discharging the second type of ink L2 onto the first type of ink. The second recording mode is a recording mode that is used when the recording target medium P is a transparent film or the like and characters, shapes, pictures or the like are shown from the surface of the side opposite to the recorded surface (the surface with the ink discharged).

Next, the relationship between the operation of the carriage 10 and the radiation control of the first radiating unit 16 is described.

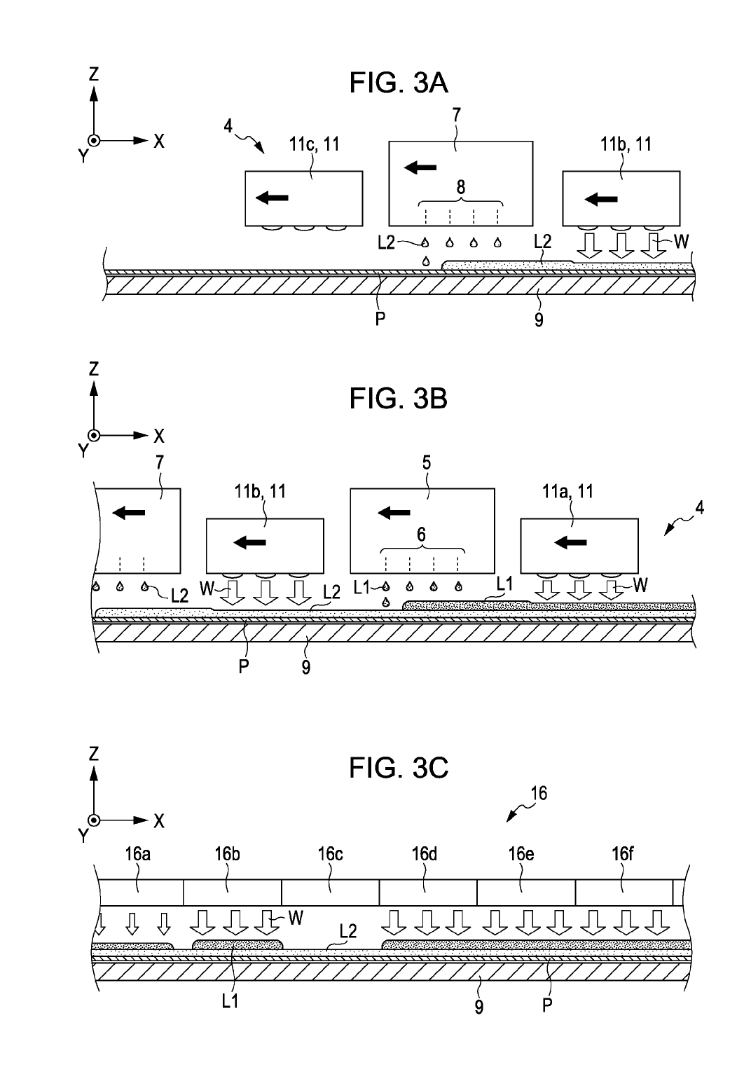

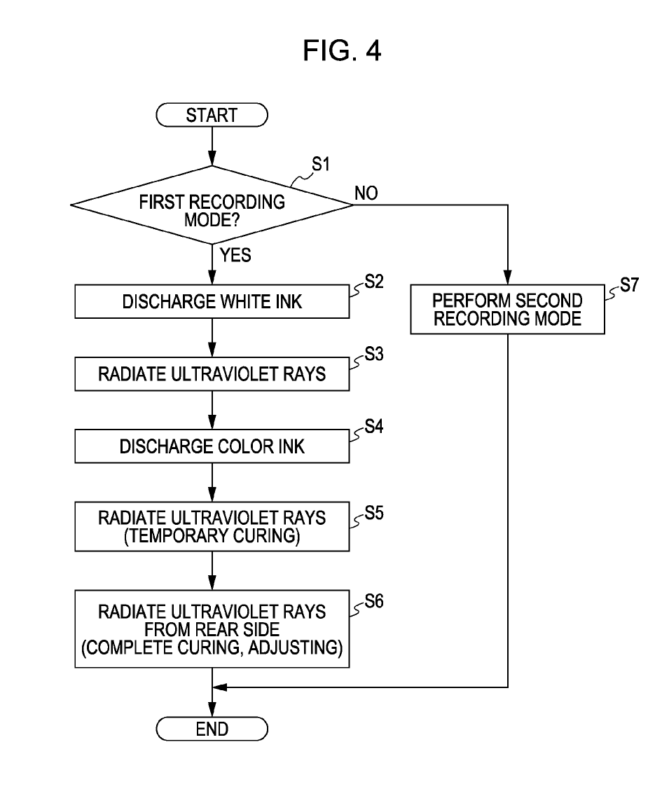

FIGS. 3A to 3C are front cross-sectional views showing the operation of the recording section 4 according to the embodiment. Further, FIG. 4 is a view showing the control of the recording section 4 according to the embodiment. FIGS. 3A to 3C are described while FIG. 4 is described. Further, the carriage 10 is not shown to make understanding of FIGS. 3A to 3C easy.

As shown in FIG. 4, in step S1, the control section 20 determines whether the recording mode that is currently selected is the first recording mode. When it is determined that the first recording mode has been selected, the first recording mode is performed and the process proceeds to step S2. On the other hand, when it is determined that the first recording mode has not been selected, the second recording mode is performed and the process proceeds to step S6.

In step S2, as shown in FIG. 3A, white ink L2 as the second type of ink L2 is discharged from the second nozzle 8 of the second recording head 7 to the rolled paper P while the carriage 10 moves. Further, the process proceeds to step S3.

In step S3, ultraviolet rays W are radiated from the second radiating unit 11b (11) behind the second recording head 7 in the movement direction such that the white ink L2 is temporarily cured.

The temporary curing implies a state in which the ink is incompletely cured before being completely cured (complete curing). This is because it is possible to improve fixation of the ink at the upper portion when ink is discharged with semi-drying repeated, as compared with when the surface of the landed ink is completely cured and completely dried.

Next, the process proceeds to step S4.

In step S4, as shown in FIG. 3B, ink L1 as the first type of ink L1 of cyan, magenta, yellow, and black is discharged from the first nozzle 6 of the first recording head 5. Next, the process proceeds to step S5.

In step S5, ultraviolet rays W are radiated by the second radiating unit 11a (11) behind the first recording head 5 in the movement direction to cure the ink L1 of cyan, magenta, yellow, and black which is landed on the rolled paper P.

Further, the radiation amount of the ultraviolet rays W depends on the amount of landed ink per unit L1 area and may be adjusted. In detail, the radiation amount is large when the landed amount is large, while the radiation amount is small when the landed amount is small. The control section 20 can determines whether the landed amount is large or small, from the amount of ink L1 discharged to the corresponding positions on the basis of recording data.

As described below, since the complete curing is performed by adjusting the radiation amount of ultraviolet rays W by the first radiating unit 16, temporary curing of the ink L1 by the second radiating unit 11 may not be performed.

Next, the process proceeds to step S6.

In step S6, the rolled paper P is transported by a predetermined distance to the downstream in the transporting direction.

The predetermined distance is a distance for the position of the rolled paper P, which faces the first recording head 5 and the second recording head 7, to face the first radiating unit 16.

Further, as shown in FIG. 3C, ultraviolet rays W are radiated by the first radiating unit 16 and the cyan, magenta, yellow, and black that are temporarily cured are completely cured.

In this process, the control section 20 performs control of changing radiation for each of the blocks 16a, 16b, . . . of the first radiating unit 16. Further, similar to step S5 described above, the radiation amount of the ultraviolet rays W depends on the amount of landed ink L1 per unit area and may be adjusted. In detail, the radiation amount is large when the landed amount is large, while the radiation amount is small when the landed amount is small. The control section 20 can determine whether the landed amount is large or small, from the amount of ink L1 discharged to the corresponding positions on the basis of recording data.

As a result, it is possible to equally cure the ink L1 at the positions where the amount of landed ink L1 per unit area is large and small, such that stain is not caused.

Further, energy is also saved because it is possible to prevent an unnecessarily large amount of ultraviolet rays W from being radiated to the positions where the amount of landed ink L1 per unit area is small.

Further, it is possible to prevent an increase in the amount of contraction of the ink L1, which is an example of a defect due to radiation of an unnecessarily large amount of ultraviolet rays W.

Further, the radiation amount for the ink L1 and L2 per unit area may be adjusted in accordance with the type of the ink L1 and L2. For example, the black component of black ink absorbs light and radiated light is absorbed at position close to the surface of ink droplets, such that the inside far from the surface may be difficult to cure. Further, since white ink using titanium oxide or metallic color-based ink using aluminum uses metal, light, such as the radiated ultraviolet rays W, is reflected from positions close to the surface of ink droplets, such that the inside far from the surface may be difficult to cure. Uniform curing without curing non-uniformity can be achieved by adjusting the radiation amount in accordance with the types of ink L1 and L2 in consideration of this inclination.

In step S7, the second recording mode described above is performed. The detailed description is not provided herein. The sequence is finished.

The printer 1 that is a recording apparatus according to the embodiment includes the medium transporting section 2 that is a section transporting the rolled paper P, which is an example of a recording target medium, in the transporting direction Y, the first recording head 5 that is a recording head that performs recording by discharging the ink L1 from the first nozzle 6 that is a nozzle to the rolled paper P, and the first radiating unit 16 that is a radiating unit that is disposed further downstream than the first recording head 5 in the transporting direction, at the same side as the first recording head 5 with respect to the rolled paper P, and can radiate ultraviolet rays W that is an example of electromagnetic waves W that cures the ink L1, in which the relationship between the ink L1 and the ultraviolet rays W is a relationship in which the ink L1 is cured by a chemical reaction generated in the ink L1 by the radiated ultraviolet rays W, the first radiating unit 16 can irradiate a range wider than the rolled paper P in the width direction X to the transporting direction of the rolled paper P, and the radiating portion of the first radiating unit 16 is divided into a plurality of blocks 16a, 16b . . . at least in the width direction X.

Further, in the embodiment, when the first radiating unit 16 performs the radiation, the radiation amount is changed for each of the blocks 16a, 16b . . . by the first radiating unit 16 in accordance with the amount of landed ink L1 per unit area at the position to be irradiated in the recording data, the radiation amount of the opposite blocks 16a, 16b . . . is reduced for the position with a small landed amount, and the radiation amount of the opposite blocks 16a, 16b . . . is increased for the position with a larger landed amount than the position with a small landed amount, more than the position with a small landed amount.

Further, in the embodiment, the amount of ultraviolet rays W radiated by the first radiating unit 16 changes in accordance with the type of the ink L1 and L2.

### Other Embodiments

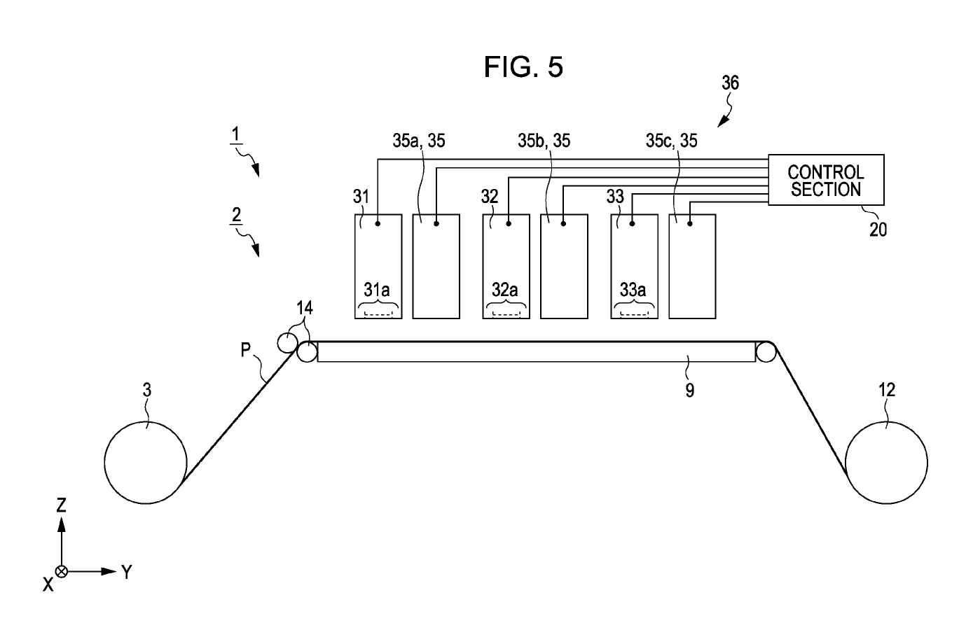

FIG. 5 is a side view schematically showing a line printer 30 that is another embodiment.

As shown in FIG. 5, a recording section 36 according to another embodiment includes a first recording head 31, a second recording head 32, and a third recording head 33, sequentially from the upstream side to the downstream side in the transporting direction. The first recording head 31 to the third recording head 33 are long in the width direction X of rolled paper P and can discharge ink L1 and L2 from each of nozzles 31a to 33a to a range larger than the width of the rolled paper P. In those components, the first recording head 31 discharges white ink L2 from the nozzle 31a. Further, the second recording head 32 discharges ink L1 of cyan, magenta, yellow, and black from the nozzle 32a. Further, the third recording head 33 discharges white ink L2 from the nozzle 33a.

Further, three of a first radiating unit 34, a second radiating unit 35, and a third radiating unit 39 that can radiate ultraviolet rays W that cures the ink L1 and L2 are disposed at the side where the first recording head 31 to the third recording head 33 are disposed with respect to the rolled paper P. In those components, the first radiating unit 34 is disposed between the first recording head 31 and the second recording head 32 and can radiate ultraviolet rays W to the position where the ink L2 discharged from the first recording head 31 is landed. Similarly, the second radiating unit 35 is disposed between the second recording head 32 and the third recording head 33 and can radiate ultraviolet rays W to the position where the ink L1 discharged from the second recording head 32 is landed. Further, similarly, the third radiating unit 39 is disposed further downstream than the third recording head 33 and can radiate ultraviolet rays W to the position where the ink L2 discharged from the third recording head 33 is landed.

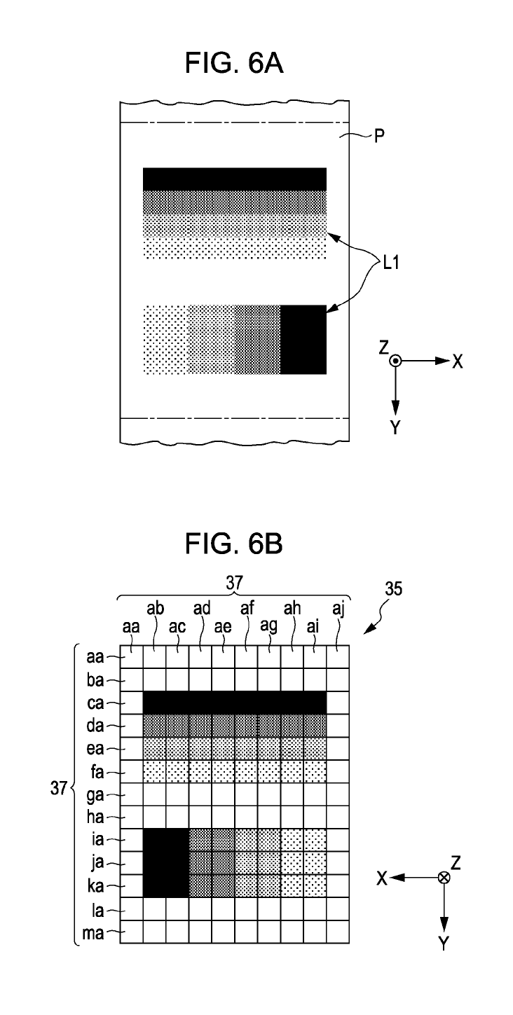

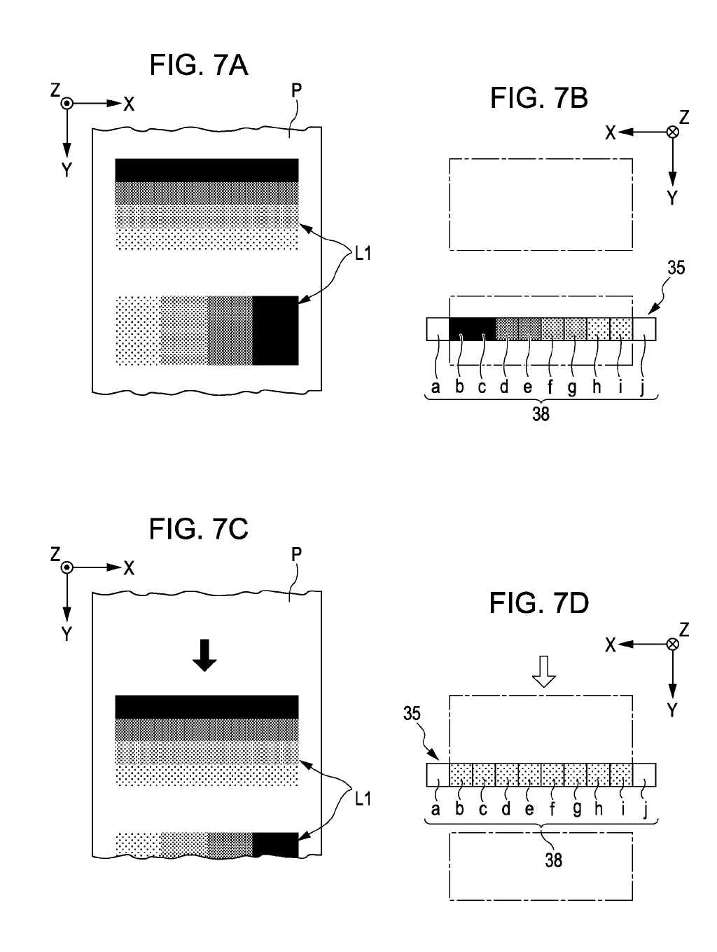

Further, the first radiating unit 34 to the third radiating unit 39 are long in the width direction X, similar to the first recording head 31 to the third recording head 33, and can radiate ultraviolet rays W to a range where ink can be discharged larger than the width of the rolled paper P by the first recording head 31 to the third recording head 33. Further, the radiating portions of the first radiating unit 34 to the third radiating unit 39 are divided into a plurality of blocks 37aa, 37ab . . . , 37ba, 37bb . . . , and 37ca . . . (38a, 38b . . . in a continuous transporting configuration) at least in the width direction (see FIGS. 6A to 7D), which is described in detail below.

This configuration is the same as that of the embodiment described above, such that like reference numerals are provided and the description is not provided.

In the first recording mode described above, white ink L2 is discharged to the rolled paper P from the first recording head 31 and ultraviolet rays W are radiated by the first radiating unit 34, thereby curing the white ink L2. Thereafter, ink L1 of cyan, magenta, yellow, and black is discharged from the second recording head 32 and ultraviolet rays W are radiated by the second radiating unit 35, such that the white ink L2 and the ink L1 of cyan, magenta, yellow, and black are completely cured.

On the other hand, in the second recording mode described above, ink L1 of cyan, magenta, yellow, and black is discharged onto the transparent rolled medium P from the second recording head 32 and ultraviolet rays W are radiated by the second radiating unit 35, such that the ink L1 of cyan, magenta, yellow, and black is temporarily cured. Thereafter, white ink L2 is discharged from the third recording head 33. Thereafter, the white ink L2 is cured by radiating ultraviolet rays W onto the white ink L2 from the third radiating unit 39. In this process, it is possible to completely cure the ink L1 of cyan, magenta, yellow, and black by radiating a sufficient amount of ultraviolet rays W to the ink L1.

Although three of the first radiating unit 34 to third radiating unit 39 are disposed, the number is not limited to three. One may be possible and two may be possible. The reason that three are disposed in this embodiment is because the ink is cured every time the ink is discharged from the recording heads 31 to 33. One radiating unit may be possible as long as the temporary curing and the complete curing are not divided.

Further, it is the same as those in the embodiment described above to adjust the radiation amount in accordance with the amount of landed ink L1 and L2 per unit area and adjust the radiation amount in accordance with the type of the ink L1 and L2. The description is not provided.

Next, the control for the blocks 37aa, 37ab . . . , 37ba, 37bb . . . , and 37ca . . . (38a, 38b . . . in a continuous transporting configuration) of the second radiating unit 35 in this embodiment will be described.

### Intermittent Transporting

FIGS. 6A and 6B are views showing the radiation amount for each of the blocks 37aa, 37ab . . . , 37ba, 37bb . . . , and 37ca . . . of the second radiating unit 35 of this embodiment. In the figures, FIG. 6A is a plan view showing the distribution of the ink L1 (L2) landed on the rolled paper P and the amount of ink L1 (L2) per unit area. Meanwhile, FIG. 6B is a bottom view showing the radiation amount for each of the blocks 37aa, 37ab . . . , 37ba, 37bb . . . , and 37ca . . . of the first radiating unit 34 having a panel shape seen from the rolled paper P.

Further, the positions with a relatively dark color concentration (positions with large dot diameters) are positions where the amount of the ink L1 (L2) landed per unit area is relatively large in FIG. 6A. Meanwhile, the positions with a relatively light color concentration (positions with small dot diameters) are positions where the amount of the ink L1 (L2) landed per unit area is relatively small.

Similarly, the positions with a relatively dark color concentration (positions with large dot diameters) are positions where the radiation amount of ultraviolet rays W is relatively large in FIG. 6B. Meanwhile, the positions with a relatively light color concentration (positions with small dot diameters) are positions where the radiation amount of ultraviolet rays W is relatively small.

When the rolled paper P is intermittently transported, the radiating portion of the second radiating unit 35 is divided into a plurality of blocks 37aa, 37ab . . . , 37ba, 37bb . . . , and 37ca . . . in a plurality of lines in the width direction X and in a plurality of rows in the transporting direction Y (see FIG. 6B).

The “intermittent transporting” is a method in which the medium transporting section 2 repeats transporting a predetermined amount of rolled paper P and pausing in the transporting direction Y. The recording section 36 performs recording on the rolled paper P during the pausing.

Further, the medium transporting section 2 repeats transporting the rolled paper P by a predetermined distance within a range where radiation is possible in the transporting direction Y of the second radiating unit 35 and pausing.

For example, as shown in FIG. 6A, during the pausing, the ink L1 is discharged to a portion of or the entire range the same size as the range where radiation of the second radiating unit 35 onto the rolled paper P is possible. Further, as the rolled paper P is intermittently transported, the range is moved to a position opposite to the second radiating unit 35 and the paper is paused.

In this process, as shown in FIG. 6B, the control section 20 determines distribution of the ink L1 in the range and the amount of the ink L1 landed per unit area on the basis of the recording data and adjusts the radiation amount of ultraviolet rays W for each of the blocks 37aa, 37ab . . . , 37ba, 37bb . . . , and 37ca . . . of the second radiating unit 35 having a panel shape.

In detail, as described above, the radiation amount of the blocks 37aa, 37ab . . . , 37ba, 37bb . . . , and 37ca . . . opposite to the positions where the ink L1 is landed is adjusted in accordance with the amount of the ink L1 per unit area at the landed positions. The radiation amount is increased for the positions where the amount of landed ink per unit area is large, while the radiation amount is decreased for the positions where the amount of ink is small. Further, when pausing is performed at the position where the range is opposite to the second radiating unit 35, the second radiating unit 35 radiates ultraviolet rays W at a time while adjusting the radiation amount for each of the blocks 37aa, 37ab . . . , 37ba, 37bb . . . , and 37ca . . . of and turning on a camera flash.

As a result, it is possible to uniformly cure the ink L1 landed in a large range at a time without curing non-uniformity.

Further, similarly, the first radiating unit 34 and the third radiating unit 39 adjust the radiation amount in accordance with the amount of ink and it is possible to uniformly cure the ink L2 landed in a large range at a time without curing non-uniformity.

The printer 30 that is a recording apparatus according this embodiment includes the medium transporting section 2 that transports the rolled paper P in the transporting direction Y, the second recording head 32 that is a recording head that performs recording by discharging the ink L1 from the nozzle 32a to the rolled paper P, and the second radiating unit 35 that is a radiating unit that is disposed further downstream than the second recording head 32 in the transporting direction, at the same side as the second recording head 32 with respect to the rolled paper P, and can radiate ultraviolet rays W that cures the ink L1, in which the relationship between the ink L1 and the ultraviolet rays W is a relationship in which the ink L1 is cured by a chemical reaction generated in the ink L1 by the radiated ultraviolet rays W, the second radiating unit 35 can irradiate a range wider than the rolled paper P in the width direction X to the transporting direction of the rolled paper P, and the radiating portion of the second radiating unit 35 is divided into a plurality of blocks 37aa, 37ab . . . , 37ba, 37bb . . . , and 37ca . . . (38a, 38b . . . in continuous transporting configuration) at least in the width direction X.

Further, for intermittent transporting in this embodiment, the radiating portion of the second radiating unit 35 is divided into a plurality of blocks 37aa, 37ab . . . , 37ba, 37bb . . . , and 37ca . . . in a plurality of lines in the width direction X and in a plurality of rows in the transporting direction Y of the rolled paper P, the rolled paper P is intermittently transported by repeating transporting the rolled paper P by a predetermined distance of the range where radiation of the second radiating unit 35 in the transporting direction Y is possible, and pausing, and during the pausing, the second radiating unit 35 performs radiation.

### Continuous Transporting

FIGS. 7A to 7D are views showing the radiation amount for each of the blocks 38a, 38b, . . . of the second radiating unit 35 of this embodiment. In the figures, FIG. 7A is a plan view showing the distribution of the ink L1 landed on the rolled paper P and the amount of ink L1 per unit area. Further, FIG. 7B is a bottom view showing the radiation amount for each of the blocks 38a, 38b, . . . of the second radiating unit 35 having a panel shape seen from the rolled paper P. Further, FIGS. 7C and 7D are a plan view and a bottom view showing a state when the rolled paper P has been transported to the downstream side in the transporting direction from the states of FIGS. 7A and 7B.

Further, the positions with relatively a dark color concentration (positions with large dot diameters) are positions where the amount of the ink L1 landed per unit area is relatively large in FIGS. 7A and 7C. Meanwhile, the positions with a relatively light color concentration (positions with small dot diameters) are positions where the amount of the ink L1 landed per unit area is relatively small.

Similarly, the positions with a relatively dark color concentration (positions with large dot diameters) are positions where the radiation amount of the ultraviolet rays W is relatively large in FIGS. 7B and 7D. Meanwhile, the positions with a relatively light color concentration (positions with small dot diameters) are positions where the radiation amount of ultraviolet rays W is relatively small.

When the rolled paper P is continuously transported, the radiating portion of the second radiating unit 35 is divided into a plurality of blocks 38a, 38b, . . . in the width direction X (see FIGS. 7B and 7D).

The “continuous transporting” is a method in which the medium transporting section 2 continuously transports the rolled paper P at a constant speed in the transporting direction Y. As the rolled paper P is transported at a constant speed, the recording section 36 performs recording on the rolled paper P.

The recording medium transporting section 2 transports the rolled paper P to the downstream in the transporting direction at a constant speed.

For example, the recording section 36 discharges the ink L1 to the rolled paper P that is moved at a constant speed and the image shown in FIG. 7A is recorded. Further, as the rolled paper P is continuously transported, a portion of the image is moved to a position opposite to the second radiating unit 35.

In this process, as shown in FIG. 7B, the control section 20 determines distribution of the ink L1 in the image on the rolled paper P and the amount of the ink L1 landed per unit area on the basis of the recording data and adjusts the radiation amount of ultraviolet rays W for each of the blocks 38a, 38b, . . . of the second radiating unit 35 having a panel shape. In detail, as described above, the radiation amount of the blocks 38a, 38b, . . . opposite to the positions where the ink L1 is landed is adjusted in accordance with the amount of the ink L1 per unit area at the landed positions. The radiation amount is increased for the positions where the amount of landed ink per unit area is large, while the radiation amount is decreased for the positions where the amount of ink is small.

Further, as shown in FIG. 7C, the rolled paper P is moved at a constant speed. On the contrary, as shown in FIG. 7D, the control section 20 changes the radiation amount of ultraviolet rays W in accordance with the amount of the ink L1 per unit area at the positions opposite to the blocks 38a, 38b, . . . of the second recording section 35. In detail, when the amount of landed ink per unit area at the opposite positions is increased, the radiation amount is increased. On the other hand, when the amount of landed ink per unit area at the opposite positions is decreased, the radiation amount is decreased.

As a result, it is possible to continuously and uniformly cure the landed ink L1 without curing non-uniformity.

Further, the blocks 38a, 38b, . . . of the second radiating unit 35 may be in one row in the transporting direction Y in the continuous transporting. Therefore, it is possible to make the line printer 30 compact in comparison to the intermittent transporting configuration.

Further, similarly, the first radiating unit 34 and the third radiating unit 39 adjust the radiation amount in accordance with the amount of ink and it is possible to continuously uniformly cure the ink L2 landed in a large range without curing non-uniformity.

In the continuous transporting of this embodiment, the rolled paper P is continuously transported at a predetermined speed, the second transporting unit 35 performs radiation while changing the radiation amount for each of the blocks 38a, 38b, . . . in accordance with the landed amount at the positions, to the positions where the ink L1 is landed on the transported rolled paper P.

Although the rolled paper P is transported in the transporting direction in this embodiment, for example, it may be possible to perform recording on the roll paper P by moving the recording section 4 in the width direction and the transporting direction, with the rolled paper P stopped. Further, it may be possible to move both of the roll paper P and the recording section 4 in the transporting direction. As described above, it may be possible to relatively move the rolled paper P and the recording section 4.

The invention is not limited to the embodiments described above and may be modified in various ways within the scope described in aspects, and the modifications should be construed as being included in the invention.

What is claimed is:

1. A recording apparatus comprising:
a transporting section that transports a recording target medium in a transporting direction;
a recording head that discharges ink to the recording target medium from a nozzle; and
a radiating unit that is disposed further downstream than the recording head in the transporting direction, at the same side as the recording head with respect to the recording target medium, and radiates electromagnetic waves that cure the ink,
wherein the radiating unit irradiates to a range wider than the recording target medium in the a first direction crossing the transporting direction, and a portion that radiates the electromagnetic waves in the radiating unit is divided into a plurality of blocks in the first direction.

2. The recording apparatus according to claim 1, comprising a control unit that controls driving of the transporting unit, the recording head, and the radiating unit,
wherein the control unit changes the radiation amount of the electromagnetic waves for each of the blocks in the radiating unit in accordance with the amount of landed ink per unit area at the position where the electromagnetic waves are radiated in the recording data.

3. The recording apparatus according to claim 2,
wherein the control unit decreases the radiation amount of the block opposite to the position with a relatively small landed amount, and increases the radiation amount of the blocks opposite to the position with a relatively larger landed amount than the position with the small landed amount, more than that for the position with the small landed amount.

4. The recording apparatus according to claim 1,
wherein the radiating portion in the radiating unit is divided into a plurality of blocks in the transporting direction.

5. The recording apparatus according to claim 4, comprising a control unit that controls driving of the transporting unit, the recording head, and the radiating unit,
wherein the control unit performs intermittent transporting that repeats transporting and pausing of the recording target medium by a predetermined distance in a range where radiation of the radiating unit is performed by the transporting unit in the transporting direction, and causes the radiating unit to radiate the electromagnetic waves to the recording target medium, when the recording target medium is paused.

6. The recording apparatus according to claim 1, comprising a control unit that controls driving of the transporting unit, the recording head, and the radiating unit,
wherein the control unit performs continuous transporting for continuously transporting the recording target medium by using the transporting unit and changes the radiation amount of the electromagnetic waves for each of the blocks in accordance with the landed amount of the ink, at the position with the ink landed on the recording target medium.

7. The recording apparatus according to claim 1, comprising a control unit that controls driving of the transporting unit, the recording head, and the radiating unit,
wherein the control unit changes the amount of electromagnetic waves radiated from the radiating unit in accordance with the type of the ink.
